(19) United States
(12) Patent Application Publication
(10) Pub. No.: US 2022/0322240 A1
(43) Pub. Date: Oct. 6, 2022

(54) TERMINAL AND METHOD FOR DETERMINING UPLINK TRANSMISSION POWER

(71) Applicant: Nanning FuLian FuGui Precision Industrial Co., Ltd., Nanning (CN)

(72) Inventor: TONG-ZHOU ZHU, Shenzhen (CN)

(21) Appl. No.: 17/685,723

(22) Filed: Mar. 3, 2022

(30) Foreign Application Priority Data
Mar. 30, 2021 (CN) 202110343268.5

(51) Int. Cl. H04W 52/14; H04W 52/34

(52) U.S. Cl. CPC H04W 52/146; H04W 52/34

(57) ABSTRACT

A terminal, includes: multiple antenna ports, configured to connect antennas; a first determining unit, configured to determine a power scaling factor and indication information, and determine capability information of the terminal according to the power scaling factor and the indication information; a sending unit, configured to receive the capability information and send the capability information to a network device; a second determining unit, configured to determine a actual uplink transmission power of the terminal according to feedback information of the network device and the capability information.

### CROSS-REFERENCE TO RELATED APPLICATIONS

This application claims priority to Chinese Patent Application No. 202110343268.5 filed on Mar. 30, 2021, the contents of which are incorporated by reference herein.

### FIELD

The present invention relates to a field of communication technology, in particular to a terminal and a method for determining uplink power.

### BACKGROUND

In the Long Term Evolution (LTE, Long Term Evolution) system, if the terminal only uploads the physical uplink control channel (PUCCH, Physical Uplink Control Channel) on part of the antenna ports configured on the network side, then the transmit power on each antenna port that transmits PUCCH can only be M/N of the calculated transmit power (that is, the power scaling factor is M/N), wherein M is a number of antenna ports used to transmit PUCCH, and N is a total number of antenna ports configured on the network side. There is no clear plan for how the terminal determines the power scaling factor according to different terminal types, that is, the uplink transmission power cannot be determined.

### BRIEF DESCRIPTION OF THE DRAWINGS

Implementations of the present technology will now be described, by way of example only, with reference to the attached figures.

FIG. 1 is a schematic diagram of modules of an embodiment of a terminal according to the present invention.

FIG. 2 is a schematic flowchart of an embodiment of a method for determining uplink transmission power according to the present invention.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The disclosure is illustrated by way of example and not by way of limitation in the figures of the accompanying drawings, in which like references indicate similar elements. It should be noted that references to “an” or “one” embodiment in this disclosure are not necessarily to the same embodiment, and such references mean at least one.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

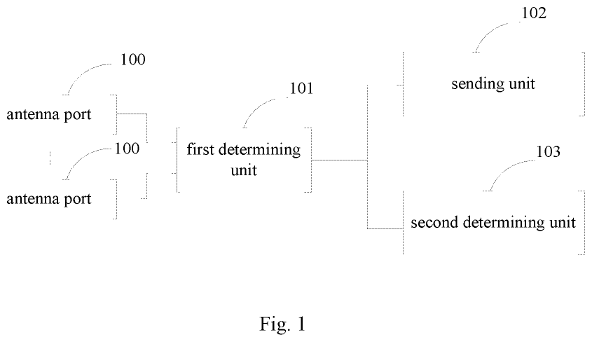

Referring to FIG. 1, FIG. 1 is a schematic structural diagram of an embodiment of a terminal 10 of the present invention. In the embodiment, the terminal 10 includes, but is not limited to, a user equipment (UE), an access terminal, a user unit, a user station, a mobile station, a computer device, or a wearable smart device. The terminal 10 comprises multiple antenna ports 100, a first determining unit 101, a sending unit 102, and a second determining unit 103. In the embodiment, each antenna port 100 corresponds to a maximum transmission power.

In at least one embodiment, the multiple antenna ports 100 are configured to connect antennas. The first determining unit, connected to the multiple antenna ports 100, is configured to determine a power scaling factor and indication information, and determine capability information of the terminal 10 according to the power scaling factor and the indication information.

Specifically, in at least one embodiment, the first determining unit 101 determines the power scaling factor of the terminal 10 according to the antenna structure, the maximum transmission power on each antenna port, and the power level of the terminal 10. Wherein, the first determining unit 101 determines the power scaling factor of the terminal separately according to one of the antenna structure, the maximum transmit power on each antenna port, and the power level of the UE, and may also determine the power scaling factor of the terminal 10 according to a combination thereof, and the application depends on actual needs.

In at least one embodiment, the first determining unit 101 configured to determine the power scaling factor, is specifically: judging whether the multiple antenna ports are associated with the device of the same radio frequency; determining that power scaling is not required if the device of the same radio frequency is associated; if there are K number of antenna ports and M number of antenna ports are configured to PUCCH transmission, the scaling factor is determined as M/K, wherein K>=M.

In at least one embodiment, the first determining unit 101 configured to determine the power scaling factor, is specifically: the power scaling factor is determined as min (1, _{Pmax, tx}/Pₜₓ) according to the maximum transmission power P_{max, tx} on each antenna port 100 and the transmission power Pₜₓ calculated based on power control parameters.

In at least one embodiment, the first determining unit 101 specifically determines the power scaling factor based on the relationship between the maximum transmission power P_{max, tx} on each antenna port and the maximum transmission power Pmax allowed by the terminal 10: when the maximum transmission power on each antenna port 100 P_{max, tx}>=Pₘₐₓ, the power scaling factor is 1; when the maximum transmit power on each antenna port 100 P_{max, tx}<Pₘₐₓ, the power scaling factor is ½ or M/N, wherein M is a number of antenna ports actually used for PUCCH transmission, and N is a number of antenna ports configured for PUCCH.

In at least one embodiment, the first determining unit 101 specifically determines the power scaling factor based on a power level of the terminal 10: when the power level of the terminal 10 is ordinary power, the power scaling factor is 1; when the power level of the terminal 10 is high power, the power scaling factor is ½ or M/N, wherein M is a number of antenna ports 100 actually used for PUCCH transmission, and N is a number of antenna ports 100 configured for PUCCH.

In at least one embodiment, the first determining unit 101 determines the indication information of the terminal 10 according to the antenna structure, the maximum transmission power on each antenna port 100, and the power level of the terminal 10. Wherein, the first determining unit 101 may determine the indication information of the terminal 10 separately according to one of the antenna structure, the maximum transmit power on each antenna port 100, and the power level of the terminal 10, and may also determine the indication information of the terminal according to a combination thereof, and the application depends on actual needs.

In at least one embodiment, the first determining unit 101 determines the indication information according to the antenna structure, specifically: determining whether the multiple antenna ports 100 are associated with the device of the same radio frequency; if yes, determining that power can be shared among the multiple antenna ports 100; if not, determining that power cannot be shared among the multiple antenna ports 100.

In at least one embodiment, the first determining unit 101 determines the indication information according to the maximum transmit power on each antenna port 100. Specifically, the first determining unit 101 determines the indication information based on the relationship between the maximum transmission power P_{max, tx} on each antenna port 100 and the maximum transmission power Pmax allowed by the terminal 10: when P_{max, tx}=Pₘₐₓ, power can be shared between antenna ports; when P_{max, tx}≠Pₘₐₓ, power cannot be shared between antenna ports.

The first determining unit 101 determines the indication information based on a power level of the terminal 10: when the power level is ordinary power, power can be shared between antenna ports 100; when the power level is a high-power, power cannot be shared between antenna ports 100.

In at least one embodiment, the sending unit 102 receives the capability information and send the capability information to a network device. The network device includes, but is not limited to, base stations in WCDMA, evolved base stations in LTE, or relay station access points, etc.

In at least one embodiment, the second determining unit 103 determines an actual uplink transmission power of the terminal 10 according to feedback information of the network device and the capability information.

In at least one embodiment, the second determining unit 103 determines the actual transmission power of the terminal 10 according to the feedback information of the network device and the capability information. Specifically, according to the power scaling factor B and the transmission power P calculated by the network device based on power control parameters, the second determining unit 103 determines the actual transmission power as K*P.

In at least one embodiment, the second determining unit 103 determines the actual uplink transmission power of the terminal 10 according to the feedback information of the network device and the capability information. Specifically, according to the maximum transmission power Pc_max supported by the terminal and the transmission power P calculated by the network device based on power control parameters, the second determining unit 103 determines the actual uplink transmission power as Min (B*P, B*Pc_max), wherein B is the scaling factor.

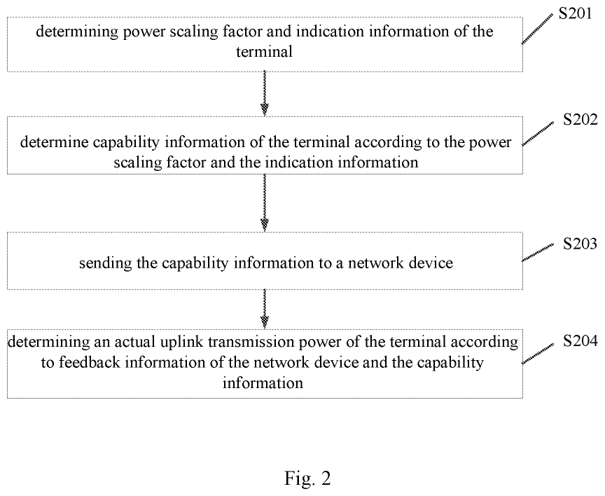

Referring to FIG. 2, which is a schematic flowchart of a method for determining uplink transmission power of the present invention. The method is applied to the aforementioned terminal 10. As shown in the figure, the method includes the following steps:

Step S201: determining power scaling factor and indication information of the terminal 10.

Specifically, in at least one embodiment, the power scaling factor of the terminal 10 can be determined according to the antenna structure, the maximum transmission power on each antenna port, and the power level of the terminal 10. Wherein, the power scaling factor of the terminal separately can be determined according to one of the antenna structure, the maximum transmit power on each antenna port, and the power level of the UE, and the power scaling factor of the terminal 10 can also be determined according to a combination thereof, and the application depends on actual needs.

In at least one embodiment, the step of determining power scaling factor, specifically comprising: judging whether the multiple antenna ports are associated with the device of the same radio frequency; determining that power scaling is not required if the device of the same radio frequency is associated; determining the scaling factor is M/K, if there are K number of antenna ports and M number of antenna ports are configured to PUCCH transmission, wherein K>=M.

In at least one embodiment, the step of determining power scaling factor, specifically comprising: determining the power scaling factor as min (1, P_{max, tx}/Pₜₓ) according to the maximum transmission power Pmax, tx on each antenna port 100 and the transmission power Pₜₓ calculated based on power control parameters.

In at least one embodiment, the step of determining power scaling factor, specifically comprising: when the maximum transmission power on each antenna port 100 P_{max, tx}>=Pₘₐₓ, the power scaling factor is 1; when the maximum transmit power on each antenna port 100 P_{max, tx}<Pₘₐₓ, the power scaling factor is ½ or M/N, wherein M is a number of antenna ports actually used for PUCCH transmission, and N is a number of antenna ports configured for PUCCH.

In at least one embodiment, the step of determining power scaling factor, specifically comprising: when the power level of the terminal 10 is ordinary power, the power scaling factor is 1; when the power level of the terminal 10 is high power, the power scaling factor is ½ or M/N, wherein M is a number of antenna ports 100 actually used for PUCCH transmission, and N is a number of antenna ports 100 configured for PUCCH.

In at least one embodiment, the indication information of the terminal 10 can be determined according to the antenna structure, the maximum transmission power on each antenna port 100, and the power level of the terminal 10. Wherein, the indication information of the terminal 10 can be determined separately according to one of the antenna structure, the maximum transmit power on each antenna port 100, and the power level of the terminal 10, and the indication information of the terminal 10 may also be determined according to a combination thereof, and the application depends on actual needs.

In at least one embodiment, the step of determining the indication information, specifically comprising: determining whether the multiple antenna ports 100 are associated with the device of the same radio frequency; if yes, determining that power can be shared among the multiple antenna ports 100; if not, determining that power cannot be shared among the multiple antenna ports 100.

In at least one embodiment, the step of determining the indication information, specifically comprising: determining the indication information based on the relationship between the maximum transmission power P_{max, tx} on each antenna port 100 and the maximum transmission power Pmax allowed by the terminal 10; when P_{max, tx}=Pₘₐₓ, power can be shared between antenna ports; when P_{max, tx}≠Pₘₐₓ, power cannot be shared between antenna ports.

In at least one embodiment, the step of determining the indication information, specifically comprising: when the power level is ordinary power, power can be shared between antenna ports 100; when the power level is a high-power, power cannot be shared between antenna ports 100.

Step S202: determine capability information of the terminal according to the power scaling factor and the indication information.

Step S203: sending the capability information to a network device.

Step S204: determining an actual uplink transmission power of the terminal according to feedback information of the network device and the capability information.

In at least one embodiment, the step of determining an actual uplink transmission power of the terminal according to feedback information of the network device and the capability information, specifically comprising: determining the actual transmission power as K*P according to the power scaling factor B and the transmission power P calculated by the network device based on power control parameters.

In at least one embodiment, the step of determining an actual uplink transmission power of the terminal according to feedback information of the network device and the capability information, specifically comprises: determining the actual uplink transmission power as Min (B*P, B*P_{c_max}) according to the maximum transmission power P_{c_max} supported by the terminal and the transmission power P calculated by the network device based on power control parameters, wherein B is the scaling factor.

Compared with the prior art, the terminal and the method for determining uplink power provided by the embodiments of the present invention determine the power scaling factor and indication information through the first determining unit, and determine the capability information of the terminal according to the power scaling factor and the indication information. Furthermore, the actual transmission power of the terminal is determined by the second determining unit according to the feedback information of the network device and the capability information, that is, the corresponding actual transmission power is determined according to the capability information of different terminals.

Many details are often found in the art such as the other features of mobile terminal. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A terminal, comprising:
multiple antenna ports configured to connect antennas;
a first determining unit configured to determine a power scaling factor and indication information, and determine capability information of the terminal according to the power scaling factor and the indication information;
a sending unit configured to receive the capability information and send the capability information to a network device; and
a second determining unit configured to determine an actual uplink transmission power of the terminal according to feedback information of the network device and the capability information.

2. The terminal of claim 1, wherein the first determining unit is further configured to determine the power scaling factor by:
determining whether the multiple antenna ports are associated with a device of a same radio frequency;
determining that power scaling is not required if the device of the same radio frequency is determined to be associated with multiple antenna ports; and
if there are K number of antenna ports and M number of antenna ports are configured to physical uplink control channel (PUCCH) transmission, the scaling factor is determined as M/K, where K>=M.

3. The terminal of claim 1, wherein the first determining unit is configured to determine the power scaling factor by:
the power scaling factor is determined as min (1, P_{max, tx}/Pₜₓ) according to the maximum transmission power P_{max, tx} on each antenna port and the transmission power Pₜₓ calculated based on power control parameters, wherein the P_{max, tx} is the maximum transmission power on each antenna port, the Pₜₓ is the transmission power.

4. The terminal of claim 1, wherein the first determining unit is configured to determine the power scaling factor based on a relationship between the maximum transmission power P_{max, tx} on each antenna port and the maximum transmission power Pₘₐₓ allowed by the terminal by:
when P_{max, tx} is equal to or larger than Pₘax, the power scaling factor is 1; and
when P_{max, tx} is less than Pₘax, the power scaling factor is ½ or M/N, wherein M is a number of antenna ports actually used for PUCCH transmission, and N is a number of antenna ports configured for PUCCH.

5. The terminal of claim 1, wherein the first determining unit is configured to determine the power scaling factor based on a power level of the terminal by:
when the power level of the terminal is an ordinary terminal, the power scaling factor is 1, wherein the ordinary terminal refers to the terminal whose power level is less than a preset value;
when the power level of the terminal is high power terminal, the power scaling factor is ½ or M/N, wherein M is a number of antenna ports actually used for PUCCH transmission, and N is a number of antenna ports configured for PUCCH, wherein the high power terminal refers to a terminal whose power level is greater than the preset value.

6. The terminal of claim 1, wherein the first determining unit is configured to determine the indication information by:
determining whether the multiple antenna ports are associated with a device of a same radio frequency;
if yes, determining that power can be shared among the multiple antenna ports; and
if not, determining that power cannot be shared among the multiple antenna ports.

7. The terminal of claim 1, wherein the first determining unit is configured to determine the indication information based on a relationship between the maximum transmission power P_{max, tx} on each antenna port and the maximum transmission power Pₘₐₓ allowed by the terminal by:
when P_{max, tx}=Pₘₐₓ, determining that power can be shared between antenna ports; and
when P_{max, tx}≠Pₘₐₓ, determining that power cannot be shared between antenna ports, wherein the Pₘₐₓ is the maximum transmission power.

8. The terminal of claim 1, wherein the first determining unit is configured to determine the indication information based on a power level of the terminal by:
when the power level is ordinary power, determining that power can be shared between antenna ports; and
when the power level is a high-power, determining that power cannot be shared between antenna ports.

9. The terminal of claim 1, wherein the second determining unit is configure to determine the actual transmission power of the terminal by:
according to a power scaling factor B and a transmission power P calculated by the network device based on power control parameters, the actual transmission power is determined to be K*P, and K is a number of antenna ports.

10. The terminal of claim 1, wherein the second determining unit is configured to determine the actual uplink transmission power of the terminal by:
according to a maximum transmission power P_{c_max} supported by the terminal and a transmission power P calculated by the network device based on power control parameters, the actual uplink transmission power is determined to be Min (B*P, B*P_{c_max}), wherein B is a scaling factor.

11. A method for determining uplink transmission power, comprising:
determining power scaling factor and indication information of the terminal;
determine capability information of the terminal according to the power scaling factor and the indication information;
sending the capability information to a network device;
determining an actual uplink transmission power of the terminal according to feedback information of the network device and the capability information.

12. The method for determining uplink transmission power of claim 11, wherein the step of determining power scaling factor, specifically comprising:
determining whether the multiple antenna ports are associated with a device of a same radio frequency;
determining that power scaling is not required if the device of the same radio frequency is associated; determining the scaling factor is M/K, if there are K number of antenna ports and M number of antenna ports are configured to PUCCH transmission, wherein K>=M.

13. The method for determining uplink transmission power of claim 11, wherein the step of determining power scaling factor, specifically comprising:
determining the power scaling factor as min (1, P_{max, tx}/Pₜₓ) according to the maximum transmission power P_{max, tx} on each antenna port and the transmission power Pₜₓ calculated based on power control parameters, wherein the P_{max, tx} is the maximum transmission power on each antenna port, the Pₜₓ is the transmission power.

14. The method for determining uplink transmission power of claim 11, wherein the step of determining power scaling factor, specifically comprising:
when the P_{max, tx}>=Pₘₐₓ, the power scaling factor is 1;
when the P_{max, tx}<Pₘax, the power scaling factor is ½ or M/N, wherein M is a number of antenna ports actually used for PUCCH transmission, and N is a number of antenna ports configured for PUCCH.

15. The method for determining uplink transmission power of claim 11, wherein the step of determining power scaling factor, specifically comprising:
when the power level of the terminal is ordinary power, the power scaling factor is 1, wherein the ordinary terminal refers to the terminal whose power level is less than a preset value;
when the power level of the terminal is high power, the power scaling factor is ½ or M/N, wherein M is a number of antenna ports actually used for PUCCH transmission, and N is a number of antenna ports configured for PUCCH, wherein the high power terminal refers to a terminal whose power level is greater than the preset value.

16. The method for determining uplink transmission power of claim 1, wherein the step of determining the indication information, specifically comprising:
determining whether the multiple antenna ports are associated with the same radio frequency;
if yes, determining that power can be shared among the multiple antenna ports;
if not, determining that power cannot be shared among the multiple antenna ports.

17. The method for determining uplink transmission power of claim 11, wherein the step of determining the indication information, specifically comprising:
determining the indication information based on the relationship between the maximum transmission power P_{max, tx} on each antenna port and the maximum transmission power Pₘₐₓ allowed by the terminal;
when P_{max, tx}=Pₘₐₓ, determining that power can be shared between antenna ports; and
when P_{max, tx}≠Pₘax, determining that power cannot be shared between antenna ports, wherein the maximum transmission power.

18. The method for determining uplink transmission power of claim 1, wherein the step of determining the indication information, specifically comprising:
when the power level is ordinary power, determining that power can be shared between antenna ports; and
when the power level is a high-power, determining that power cannot be shared between antenna ports.

19. The method for determining uplink transmission power of claim 11, wherein the step of determining an actual uplink transmission power of the terminal according to feedback information of the network device and the capability information, specifically comprising:
determining the actual transmission power as K*P according to the power scaling factor B and the transmission power P calculated by the network device based on power control parameters, wherein K is a number of antenna ports.

20. The method for determining uplink transmission power of claim 11, wherein the step of determining an actual uplink transmission power of the terminal according to feedback information of the network device and the capability information, specifically comprising:
determining the actual uplink transmission power as Min (B*P, B*P_{c_max}) according to the maximum transmission power P_{c_max} supported by the terminal and the transmission power P calculated by the network device based on power control parameters, wherein B is the scaling factor.
